(19) United States
(12) Patent Application Publication
(10) Pub. No.: US 2006/0169902 A1
(43) Pub. Date: Aug. 3, 2006

(54) Infrared sensor

(75) Inventor: Kazuaki Watanabe, Nagoya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/340,556

(22) Filed: Jan. 27, 2006

(30) Foreign Application Priority Data
Feb. 1, 2005 (JP) 2005-025397

(51) Int. Cl. G01J 5/00

(52) U.S. Cl. 250/338.1

(57) ABSTRACT

An infrared sensor includes a substrate having a cavity, a membrane bridging the cavity, a thermopile-type infrared light sensing element, an infrared light absorption film located over the membrane in correspondence with positions of hot junctions of the thermopile, and an infrared light reflection coating located over the substrate to shield an area not covered by the infrared light absorption film. The coverage of the infrared light reflection coating is sufficient to shield an area not covered by the infrared light absorption film to improve the detection sensitivity of the sensor.

### CROSS REFERENCE TO RELATED APPLICATION

This application is based upon, claims the benefit of priority of, and incorporates by reference the contents of Japanese Patent Application No. 2005-025397 filed on Feb. 1, 2005.

### FIELD OF THE INVENTION

The present invention relates to an infrared sensor. The infrared sensor may employ a thermopile sensing element, a bolometric sensing element, a pyroelectric sensing element or any other infrared sensing element that outputs a signal corresponding to the infrared light received.

### BACKGROUND OF THE INVENTION

For example, JP-A-H06-137943 discloses an infrared sensor that employs a thermopile sensing element. The thermopile sensing element includes a plurality of thermocouples connected in series and detects incident infrared light, using the Seebeck effect, in which a thermoelectromotive potential is induced between cold junctions and hot junctions of the thermocouples.

The infrared sensor disclosed in the above publication is constituted by a silicon substrate, a thermopile sensing element located on the silicon substrate, and circuitry formed in the silicon substrate at an area where the thermopile sensing element is not located.

The thermopile sensing element has a membrane composed of an upper silicon oxide layer and a lower silicon nitride layer, a thermopile pattern located between the upper silicon oxide layer and the lower silicon nitride layer of the membrane, a cavity located between the membrane and the upper surface of the silicon substrate, an infrared-light reflection coating located on the upper surface of the silicon substrate within the cavity, and an infrared-light absorption film located on the membrane opposite to the infrared-light reflection coating. Hot junctions of the thermopile pattern are located on the membrane and between the infrared-light reflection coating and the infrared-light absorption film, and cold junctions of the thermopile pattern are located on the silicon substrate to be thermally isolated from the hot junctions by the cavity. Furthermore, a metal layer is formed on a peripheral portion of the membrane to prevent infrared light from reaching the circuitry.

However, the present inventor confirmed that, even though a metal layer for blocking infrared light is provided, like sensor of the above-mentioned publication, if the coverage of the metal layer is insufficient, infrared light that is incident on a membrane tends to cause heat accumulation or heat propagation, and thus, the temperature at cold junctions increases. That is, the differences in temperature between cold junctions and hot junctions decrease, and therefore the sensitivity of the sensor to infrared light degrades. Particularly, according to the above-mentioned publication, since a membrane has a step portion due to the formation of the cavity, the coverage of a metal layer may be insufficient.

### SUMMARY OF THE INVENTION

In view of the foregoing problem, it is an object to provide an infrared sensor that can improve the detection sensitivity of infrared light.

An infrared sensor according to an aspect of the present invention includes a substrate having a region, an infrared light sensing element having a thermal accepting portion for receiving heat due to incident infrared light, wherein the infrared light sensing element is located over the region, an infrared light absorption film located over the region in correspondence with the thermal accepting portion of the infrared light sensing element, and an infrared light reflector located over the substrate to shield any portion of the infrared light sensing element not covered by the infrared light absorption film.

Accordingly, the coverage of the infrared light reflector according to the invention may be sufficient to shield any portion of the infrared light sensing element that is not covered by the infrared light absorption film, and thereby an infrared sensor according to the invention can improve the sensitivity of the sensor to infrared light as compared with the conventional infrared sensor described above.

### BRIEF DESCRIPTION OF THE DRAWINGS

The above and other objects, features and advantages of the present invention will become more apparent from the following description of the preferred embodiments given with reference to the attached drawings, wherein:

FIG. 1A is a cross sectional view showing the schematic construction of an infrared sensor according to a first embodiment;

FIG. 1B is a plan view of the infrared sensor of the first embodiment;

FIG. 1C is a circuit diagram showing a sensor output Vout;

FIG. 2 is a cross sectional view showing the schematic construction of an infrared sensor assembly that employs the infrared sensor of the first embodiment;

FIG. 3 is a cross sectional view showing the schematic construction of an infrared sensor according to a second embodiment;

FIG. 4 is an explanatory view showing reflection of infrared light by an infrared light reflection coating of the second embodiment; and

FIG. 5 is a cross sectional view showing the schematic construction of an infrared sensor according to a third embodiment.

### DETAILED DESCRIPTION OF THE PREFERRED EMBODIMENTS

Preferred embodiments according to the present invention will be described hereunder with reference to the accompanying drawings.

### First Embodiment

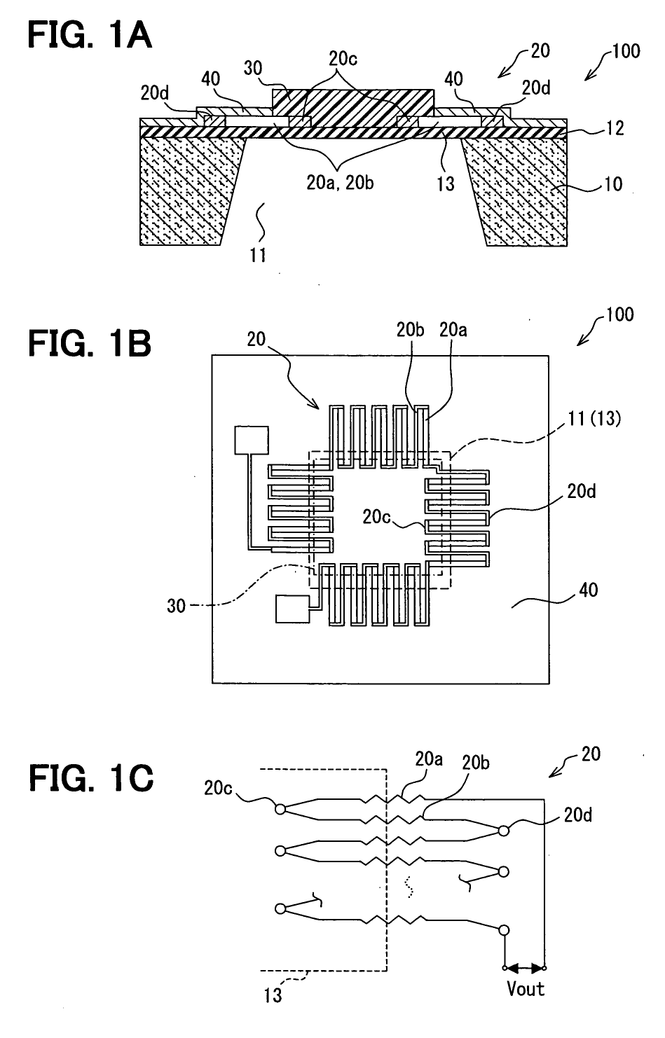

FIGS. 1A, 1B and 1C show schematically the construction of a thermopile-type infrared sensor 100 according to a first embodiment. As shown in FIG. 1A, the infrared sensor 100 mainly includes a substrate 10, a sensing element 20, an infrared light absorption film 30, and an infrared light reflection coating 40. The substrate 10 is a semiconductor substrate formed of, for example, silicon, and has a cavity 11 that is formed by wet etching from the rear surface of the substrate 10. In this embodiment, the cavity 11 opens at the rear surface to have a certain rectangular area, and the area of the opening is tapered, as shown, toward the upper surface side of the substrate 10. The rectangular opening at the upper surface of the substrate 10 is indicated by a dashed broken line in FIG. 1B and corresponds to a formation area of a membrane 13 as a thin part. The region surrounding the rectangular area indicated by the dashed broken line in FIG. 1B is a thick part where bonding pads and, if necessary, any processing circuit elements may be located. In FIG. 1B, another rectangular area surrounded by a dashed and dotted broken line represents a formation area of the infrared light absorption film 30.

As shown in FIG. 1A, an insulation film 12 such as a silicon nitride layer, a silicon oxide layer or a multilayer structure of silicon nitride and silicon oxide, for example, is formed over the upper surface of the substrate 10, bridging the opening of the cavity 11. Accordingly, the membrane 13 is formed from the insulation film 12 and is located above the cavity 11 with respect to the substrate 10. In this embodiment, the insulation film 12 is composed of a multilayer structure, which includes a silicon nitride layer formed on the substrate 10 by a CVD method and a silicon oxide layer formed on the silicon nitride layer by a CVD method.

Using a semiconductor substrate as the substrate 10 makes it possible to easily form the membrane 13 by general semiconductor processes. In other words, a high sensitivity infrared sensor 100 can be manufactured at low cost. In place of the semiconductor substrate, a glass substrate or the like may be applied as the substrate 10.

The sensing element 20 includes a plurality of thermocouples. The thermocouples are located on the insulation film 12 and extend from the thin part (the membrane 13) to the thick part of the substrate 10 and are connected in series to constitute a thermopile pattern as shown in FIGS. 1A and 1B. That is, as shown in FIG. 1C, the plurality of thermocouples, each of which includes heterogeneous film-components 20a and 20b, are connected in series so that junctions 20c and 20d are alternately arranged over the thin part and the thick part. The junctions 20c located on the thin part (the membrane 13) function as hot junctions, and the junctions 20d located over the thick part (the substrate 10) function as cold junctions.

For example, the combination of an aluminum film and a polycrystalline silicon film may be employed as the heterogeneous film-components 20a and 20b to form a thermocouple. Although FIG. 1A does not show it in detail, a polycrystalline silicon film is formed on the insulation film 12 and patterned into a first pattern for constituting first film-components 20a of the thermopile pattern, and an aluminum film is formed over the first film-components 20a with an interlayer insulation film such as an BPSG (Boron-doped Phospho-Silicate Glass) film interposed therebetween and patterned into a second pattern for constituting second film-components 20b of the thermopile pattern. The first and second film-components 20a and 20b are connected via through holes, which are provided in the interlayer insulation film at both ends of the film-components 20a. The aluminum film may be patterned so that the second pattern includes the bonding pads and interconnections connecting between the sensing element 20 and the bonding pads.

The hot junctions 20c are located on the thin part (membrane 13) where the heat capacity thereof is relatively small, and the cold junctions 20d are located on the thick part (substrate 10 outside the membrane 13) where the heat capacity thereof is relatively large. Accordingly, the substrate 10 serves as a heat sink.

The infrared light absorption film 30 is located over the membrane 13 and covers the hot junctions 20c of the sensing element 20 as shown in FIGS. 1A and 1B. As described above, the rectangular area surrounded by the dashed and dotted broken line in FIG. 1B represents the formation area of the infrared light absorption film 30. Here, although FIG. 1A does not show it in detail, a protection film of silicon nitride or the like is formed to cover the sensing element 20, the interconnections and bonding pads described above, and the infrared light absorption film 30 is located above the protection film. The protection film has openings at the bonding pads in order to allow wire-bonding.

The infrared light absorption film 30 is composed of a material absorbing infrared light efficiently, and in this embodiment, the infrared light absorption film 30 is formed by screen-printing polyester resin with carbon particles and by fire-hardening the screen-printed film. The infrared light absorption film 30 absorbs incident infrared light and makes the temperature at the hot junctions 20c increase efficiently.

Furthermore, in this embodiment, the coverage of the infrared light absorption film 30 with respect to the membrane 13 is determined so that the infrared light absorption film 30 is within a projection of the membrane 13 and spaced from the peripheral border of the membrane 13, and that a ratio A/C of a width A of the infrared light absorption film 30 to a width C of the membrane 13 is within 0.75-0.90. This relationship between the infrared light absorption film 30 and the membrane 13 is disclosed in JP-A-2002-365140 and US-B-6870086, the contents of which are incorporated herein by reference, and thus the description thereof is omitted.

The infrared light reflection coating 40 prevents infrared light from reaching areas other than the infrared light absorption film 30. The infrared light reflection coating 40 is composed of a material having a high infrared reflectance, and in this embodiment, a metal layer of Au, Al, Ag or the like is used as the infrared light reflection coating 40. Furthermore, it may be applicable to use, as the infrared light reflection coating 40, a multilayer structure where dielectric layers having different refraction indexes are stacked alternately or a resin film having a high infrared reflectance. The infrared light reflection coating 40 may be formed by an evaporation or sputtering method, and may be located to cover the entire periphery of, and be in contact with, the infrared light absorption film 30. In case the infrared light reflection coating 40 is composed of electrically conductive material, the infrared light reflection coating 40 should be isolated from the sensing element 20, the bonding pads, and the interconnections. For example, the protection film described above may be employed as an insulation layer.

As described above, the infrared sensor 100 according to this embodiment is structured so that the hot junctions 20c of the sensing element 20 are located on the membrane 13 and covered with the infrared light absorption film 30. The cold junctions 20d are located over the thick part of the substrate 10, which serves as a heat sink, and are covered with the infrared light reflection coating 40. Furthermore, the coverage of the infrared light reflection coating 40 is sufficient to shield all areas other than the infrared light absorption film 30 from infrared irradiation.

Accordingly, when infrared light is irradiated from a heat source such as a human body, the infrared light absorption film 30 receives and absorbs the infrared light, and the temperature of the infrared light absorption film 30 increases, which produces an increase in temperature at the hot junctions 20c underlying the infrared light absorption film 30. On the other hand, since the substrate serves as heat sink and incidence of infrared light is prevented by the infrared light reflection coating 40, the temperature at the cold junctions 20d is not increased by the infrared light. Thus, the differences in temperature between the cold junctions 20d and the hot junctions 20c can be relatively large according to this embodiment.

Here, the incident infrared light is detected as a thermoelectromotive potential due to the differences in temperature between the cold junctions 20d and the hot junctions 20c, which is well-known as the Seebeck effect. The summation of thermoelectromotive potentials induced by a plurality of pairs of film-components 20a and 20b, which constitutes the thermopile pattern, is an output Vout of the sensing element 20 as shown in FIG. 1C. Accordingly, since the differences in temperature between the cold junctions 20d and the hot junctions 20c is relatively large, the detection sensitivity, i.e., responsivity, with respect to infrared light is improved as compared with the above-mentioned conventional infrared sensor.

Furthermore, according to this embodiment, an underlying surface of the thermopile pattern is relatively flat, and the membrane 13 is substantially free from steps due to the formation of the cavity. Therefore, the infrared light reflection coating 40 is easily located close to the infrared light absorption film 30. Thus, the coverage of the infrared light reflection coating 40 is easily improved as compared with the conventional infrared sensor.

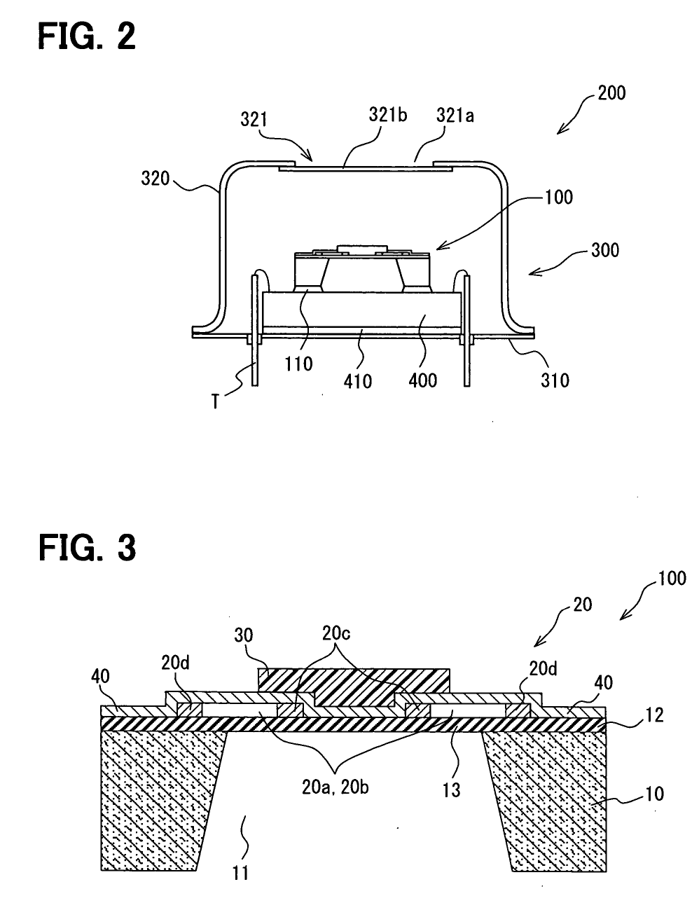

FIG. 2 shows an example of an infrared sensor assembly 200 in which the infrared sensor 100 of the first embodiment is installed.

The infrared sensor assembly 200 has a so-called can-packaged structure. The infrared sensor 100 is installed in the interior space of a case 300, which includes a pedestal 310 and a cap 320 attached to the pedestal 310.

More specifically, a processing IC chip 400 is adhered on the pedestal 310 with an adhesive 410, and the infrared sensor 100 is stacked on the processing IC chip 400 with an adhesive 110. Pins T as output terminals penetrate the pedestal 310 and are hermetically sealed. The pins T are wire-bonded with the processing IC chip 400, and the infrared sensor 100 is also electrically connected to the processing IC chip 400 via bonding-wires (not shown). In this state, the cap 320 is attached to the pedestal 310, accommodating the infrared sensor 100 and the processing IC chip 400 inside the interior space of the case 300.

The cap 320, which is composed of metal, has a cylindrical shape and is equipped with an incidence part 321 for transmitting infrared light into the interior of the case 300. The incidence part 321 is opposite to the pedestal 310 to correspond to the infrared light absorption film 30 of the infrared sensor 100. The incidence part 321 includes an opening 321a formed on the cap 320 and an infrared filter 321b, which hermetically seals the opening 321a. Accordingly, when infrared light enters the interior space of the case 300, infrared light at an infrared wavelength region is selectively introduced to the infrared light absorption film 30 of the infrared sensor 100 by the infrared filter 321b. Also, since the incidence part 321 is opposite to the infrared light absorption film 30, incidence of infrared light onto the infrared light absorption film 30 is effective.

Although the above embodiment is an example in which the infrared sensor 100 is located on the pedestal 310 with the processing IC chip 400 located therebetween, the present invention is not limited to this multi-chip stacked structure. The infrared sensor 100 may be mounted directly on the pedestal 310 with an adhesive.

### Second Embodiment

FIG. 3 shows the schematic construction of a thermopile-type infrared sensor 100 according to the second embodiment. The infrared sensor 100 according to the second embodiment has many parts common to the infrared sensor of the first embodiment. Therefore, the same reference numerals are given to corresponding or similar parts, and a detailed description of the common parts is omitted from the following description, and different parts will be mainly described.

In the first embodiment, the infrared light reflection coating 40 is located only at the region surrounding the infrared light absorption film 30. However, in this (second) embodiment, an infrared light reflection coating 40 is located not only at the surrounding region but also a region underlying an infrared light absorption film 30. That is, the infrared light reflection coating 40 covers entirely the upper surface of the substrate 10 and thereby covers the entire thermopile pattern, including hot junctions 20c of the thermocouples located under the infrared light absorption film 30.

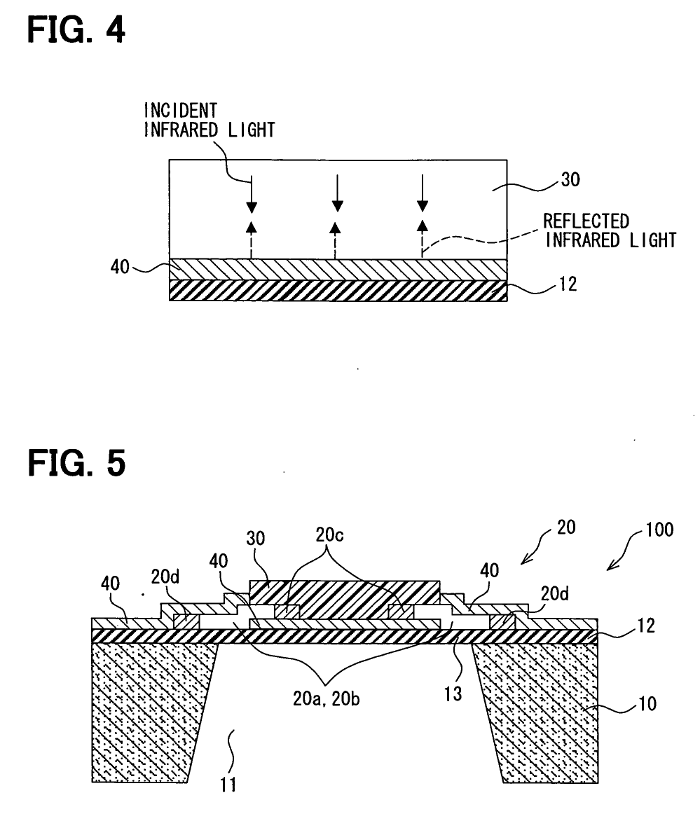

As shown in FIG. 4, even if some of the incident infrared light penetrates the infrared light absorption film 30, the underlying infrared light reflection coating 40 reflects any penetrating light that reaches the bottom of the infrared light absorption film 30. Therefore, providing the infrared light reflection coating 40 under the infrared light absorption film 30 makes it possible for the absorption film to re-absorb the penetrating infrared light. The infrared absorption by the infrared light absorption film 30 is thus more efficient. Therefore, the differences in temperature between the cold junctions 20d and the hot junctions 20c will be increased.

### Third Embodiment

FIG. 5 shows the schematic construction of a thermopile-type infrared sensor 100 according to the third embodiment. The infrared sensor 100 according to the second embodiment has many parts common to the infrared sensor of the first and second embodiments. Therefore, the same reference numerals are given to corresponding or similar parts, and a detailed description of the common parts is omitted from the following description, and different parts will be mainly described.

In the second embodiment, the infrared light reflection coating 40 entirely covers the sensing element 20 with a single layer structure. However, in this (third) embodiment, an infrared light reflection coating 40 has an overlying part and an underlying part as shown in FIG. 5. That is, the overlying part of the infrared light reflection coating 40 surrounds the infrared light absorption film 30 and is laid over the cold junctions 20d like the first embodiment. The underlying part of the infrared light reflection coating 40 is located under the infrared light absorption film 30. The hot junctions 20c are located between the underlying part of the reflection coating 40 and the absorption film 30.

Like the second embodiment, even if some of the incident infrared light penetrates the infrared light absorption film 30, the underlying part of the infrared light reflection coating 40 reflects the penetrating light. Thus, the infrared absorption by the infrared light absorption film 30 is highly efficient because of the reflection of the penetrating infrared light by the underlying part. Therefore, the third embodiment also increases the differences in temperature between the cold junctions 20d and the hot junctions 20c.

In the above-preferred embodiments, although the cavity 11 is formed by wet etching, which is carried out from the rear surface side of the substrate 10, instead, a concavity may be formed on the upper surface of a substrate. The concavity may be formed by etching from the primary surface side where the membrane is located.

Furthermore, although the above-mentioned embodiments employ the thermopile-type infrared sensor, any type of infrared sensor may be employed in so far as it generates an electrical signal on the basis of temperature variation occurring when it receives infrared light. Accordingly, in place of the thermocouple, a bolometer type sensing element equipped with a resistor or a pyroelectric type sensing element equipped with a pyroelectric film may be used as the sensing element 20. Further, the constituents of the thermocouple as the sensing element 20 are not limited to the combination of polycrystalline silicon and aluminum, any combinations may be applicable for the thermocouple.

While the invention has been described with reference to preferred embodiments thereof, it is to be understood that the invention is not limited to the preferred embodiments and constructions. The invention is intended to cover various modifications and equivalent arrangements. In addition, the various combinations and configurations, which are preferred, other combinations and configurations, including more, less or only a single element, are also within the spirit and scope of the invention.

What is claimed is:

1. An infrared sensor comprising:
a substrate having a region;
an infrared light sensing element having a thermal accepting portion for receiving heat due to incident infrared light, wherein the infrared light sensing element is located over the region;
an infrared light absorption film located over the region in correspondence with the thermal accepting portion of the infrared light sensing element; and
an infrared light reflector located over the substrate to shield any portion of the infrared light sensing element not covered by the infrared light absorption film.

2. The infrared sensor according to claim 1, wherein the region of the substrate has a flat surface on which the infrared light sensing element is located.

3. The infrared sensor according to claim 1, wherein the infrared light reflector contacts the infrared light absorption film.

4. The infrared sensor according to claim 1, wherein the infrared light reflector entirely covers the infrared light sensing element.

5. The infrared sensor according to claim 1, wherein a part of the infrared light reflector is located between the infrared light absorption film and the substrate.

6. The infrared sensor according to claim 5, wherein the infrared light reflector is a single layer structure.

7. The infrared sensor according to claim 5, wherein the infrared light reflector has a first part, which is located at an area of the infrared light sensing element that is not covered by the infrared light absorption film, wherein the first part contacts the infrared light absorption film, and a second part, which is entirely located between the infrared light absorption film and the substrate.

8. The infrared sensor according to claim 1, wherein the substrate has a thin part within the region, and a thick part surrounding the thin part.

9. The infrared sensor according to claim 8, wherein the substrate has a cavity and a membrane bridging the cavity, and the membrane forms the thin part.

10. The infrared sensor according to claim 9, wherein the thermal accepting portion of the infrared light sensing element is located over the membrane.

11. An infrared sensor comprising:
a substrate having a membrane;
an infrared light sensing element including a thermocouple, wherein a hot junction of the thermocouple is located on the membrane and a cold junction of the thermocouple is located on a region surrounding the membrane;
an infrared light absorption film located over the membrane to cover the hot junction of the thermocouple; and
an infrared light reflector located over an area of the infrared light sensing element that is not covered by the infrared light absorption film.

12. The infrared sensor according to claim 11, wherein the substrate has a flat surface on which the thermopile is located.

13. The infrared sensor according to claim 11, wherein the infrared light reflector contacts the infrared light absorption film.

14. The infrared sensor according to claim 11, wherein the infrared light reflector entirely covers the thermocouple.

15. The infrared sensor according to claim 11, wherein a part of the infrared light reflector is located between the infrared light absorption film and the substrate.

16. The infrared sensor according to claim 15, wherein the infrared light reflector is a single layer structure.

17. The infrared sensor according to claim 15, wherein the infrared light reflector has a first part, which is located at the area of the infrared light sensing element that is not covered by the infrared light absorption film, wherein the first part contacts the infrared light absorption film, and a second part, which is entirely located between the infrared light absorption film and the substrate.

18. An infrared sensor comprising:
a substrate having a membrane;
an infrared light sensing element including a thermocouple, wherein a hot junction of the thermocouple is located on the membrane and a cold junction of the thermocouple is located on a region surrounding the membrane;
an infrared light absorption film located over the membrane to cover the hot junction of the thermocouple; and
an infrared light reflector entirely covering the thermocouple, the infrared light absorption film being laid over the infrared light reflector and over the membrane.

19. The infrared sensor according to claim 1, wherein the infrared sensor is part of an assembly that includes:
a pedestal on which the infrared sensor is located;
a cap fixed to the pedestal to accommodating the infrared sensor in an inner space formed by the pedestal and the cap, the cap having a opening; and
an infrared filter fixed to the opening of the cap.

20. The infrared sensor according to claim 19, wherein the opening of the cap is located oppositely to the infrared light absorption film of the infrared sensor.
